(19) United States
(12) Patent Application Publication
(10) Pub. No.: US 2003/0105541 A1
(43) Pub. Date: Jun. 5, 2003

(54) System and method for managing work in process (WIP) handling instructions

(75) Inventors: Chi-Sen Hsu, Hsinchu (TW); Shu-Ling Feng, Hsinchu (TW); Yun-Wen Liao, Hsinchu (TW)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 09/998,343

(22) Filed: Nov. 30, 2001

(51) Int. Cl. G06F 19/00

(52) U.S. Cl. 700/100; 700/96

(57) ABSTRACT

Within both a system for managing a work in process (WIP) workload lot within a fabrication facility and a method for managing the work in process (WIP) workload lot within the fabrication facility, there is provided for direct customer access for requesting a change in handling instructions for the work in process (WIP) workload lot within the fabrication facility. The direct customer access when requesting the change provides for enhanced flexibility when operating the fabrication facility.

### BACKGROUND OF THE INVENTION

1. Field of the Invention

The present invention relates generally to systems and methods for managing fabrication facility production. More particularly, the present invention relates to systems and methods for flexibly managing fabrication facility production.

2. Description of the Related Art

Microelectronic fabrications are formed from microelectronic substrates over which are formed patterned microelectronic conductor layers which are separated by microelectronic dielectric layers.

Common in the art of microelectronic fabrication for use when fabricating microelectronic fabrications within microelectronic fabrication facilities is the use of production control systems for scheduling and routing microelectronic fabrication work in process (WIP) workload lots within microelectronic fabrication facilities. Production control systems are desirable in the art of microelectronic fabrication for scheduling and routing microelectronic fabrication work in process (WIP) workload lots within microelectronic fabrication facilities insofar as absent production control systems within fabrication facilities, such as but not limited to microelectronic fabrication facilities, production from such facilities is often not readily efficiently realized.

While production control systems are thus clearly desirable in the art of microelectronic fabrication and often essential in the art of microelectronic fabrication, production control systems are nonetheless not entirely without problems in the art of microelectronic fabrication.

In that regard, production control systems do not always provide optimal flexibility with respect to scheduling and routing work in process (WIP) workload lots within fabrication facilities, such as microelectronic fabrication work in process (WIP) workload lots within microelectronic fabrication facilities.

It is thus desirable in the art of microelectronic fabrication to provide production control systems with enhanced flexibility for managing microelectronic fabrication production within microelectronic fabrication facilities.

It is towards the foregoing object that the present invention is directed.

Various systems and methods have been disclosed within various fabrication arts for assisting in operation of fabrication facilities as employed within the various fabrication arts.

Included among the systems and methods, but not limited among the systems and methods, are systems and methods disclosed within: (1) Tullis, in U.S. Pat. No. 5,140,537 (a method for modeling production within a fabrication facility, such as to provide for enhanced efficiency when operating the fabrication facility, by employing when modeling the production within the fabrication facility a determination of human operator characteristics within the fabrication facility, a determination of machine characteristics within the fabrication facility and a determination of human-machine interaction characteristics within the fabrication facility); and (2) Chacon, in U.S. Pat. No. 6,128,588 (a production control system for effecting, with enhanced efficiency, production within a fabrication facility by providing within the fabrication facility the production control system also having incorporated therein production simulation capabilities).

Desirable in the art of microelectronic fabrication are additional systems and methods which may be employed for more flexibly managing microelectronic fabrication production within microelectronic fabrication facilities.

It is towards the foregoing object that the present invention is directed.

### SUMMARY OF THE INVENTION

A first object of the present invention is to provide a system and a method for managing production within a microelectronic fabrication facility.

A second object of the present invention is to provide the system and the method in accord with the first object of the present invention, wherein the production is flexibly managed within the microelectronic fabrication facility.

A third object of the present invention is to provide a system and a method in accord with the first object of the present invention and the second object of the present invention, wherein the system and the method are readily commercially implemented.

In accord with the objects of the present invention, there is provided by the present invention a system for managing a work in process (WIP) workload within a fabrication facility and a method for managing the work in process (WIP) workload within the fabrication facility.

In accord with the present invention, the system for managing the work in process (WIP) workload within the fabrication facility comprises: (1) a means for storing identifying information for a work in process (WIP) workload lot; (2) a means for accessing the identifying information for the work in process (WIP) workload lot; and (3) a means for requesting and effecting a change in production of the work in process (WIP) workload lot after accessing the identifying information for the work in process (WIP) workload lot, wherein the means for requesting the change in production of the work in process (WIP) workload lot provides for direct access by a customer.

The system for managing the work in process (WIP) workload within the fabrication facility in accord with the present invention contemplates the method for managing the work in process (WIP) workload within the fabrication facility in accord with the present invention.

The present invention provides a method and a system for managing production within a microelectronic fabrication facility, wherein the system and the method provide for flexibly managing the production within the microelectronic fabrication facility.

The system of the present invention and the method of the present invention realize the foregoing object by providing direct customer access to a production control system for requesting, and preferably also effecting, a change in lot handling instructions for a work in process (WIP) workload lot within the fabrication facility, which preferably is preferably a microelectronic fabrication work in process (WIP) workload lot within a microelectronic fabrication facility.

The system of the present invention and the method of the present invention are readily commercially implemented.

The present invention employs data acquisition apparatus and data processing apparatus as are generally conventional in arts including but not limited to microelectronic fabrication arts, but programmed and assembled such as to effect the objects of the present invention. Since it is thus at least a programming of a data acquisition apparatus and a data processing apparatus which provides at least in part the present invention, rather than the existence of the data acquisition apparatus and the data processing apparatus which provides the present invention, the system of the present invention and the method of the present invention are readily commercially implemented.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic block diagram illustrating a preferred embodiment of a system in accord with the present invention.

FIG. 2 shows a schematic block diagram illustrating operation of the preferred embodiment of the system in accord with the present invention, further in accord with a preferred embodiment of a method in accord with the present invention.

FIG. 3 to FIG. 8 show a series of user interface screens which may be employed within the context of the preferred embodiment of the system of the present invention and the preferred embodiment of the method of the present invention.

### DESCRIPTION OF THE PREFERRED EMBODIMENT

The present invention provides a method and a system for managing production within a microelectronic fabrication facility, wherein the system and the method provide for flexibly managing the production within the microelectronic fabrication facility.

The system of the present invention and the method of the present invention realize the foregoing object by providing direct customer access to a production control system for requesting, and preferably also effecting, a change in lot handling instructions for a work in process (WIP) workload lot within a fabrication facility, which preferably is preferably a microelectronic fabrication work in process (WIP) workload lot within a microelectronic fabrication facility.

Although the preferred embodiment of the present invention illustrates the present invention most preferably within the context of managing a work in process (WIP) workload within a microelectronic fabrication facility, the present invention is not so limited. Rather the present invention may be employed for managing work in process (WIP) workloads within fabrication facilities including but not limited to electrical fabrication facilities, chemical fabrication facilities, mechanical fabrication facilities and microelectronic fabrication facilities. Further, within the context of microelectronic fabrication facilities, the present invention may be employed for managing work in process (WIP) workload within microelectronic fabrication facilities selected from the group including but not limited to integrated circuit microelectronic fabrication facilities, ceramic substrate microelectronic fabrication facilities, solar cell optoelectronic microelectronic fabrication facilities, sensor image array optoelectronic microelectronic fabrication facilities and display image array optoelectronic microelectronic fabrication facilities.

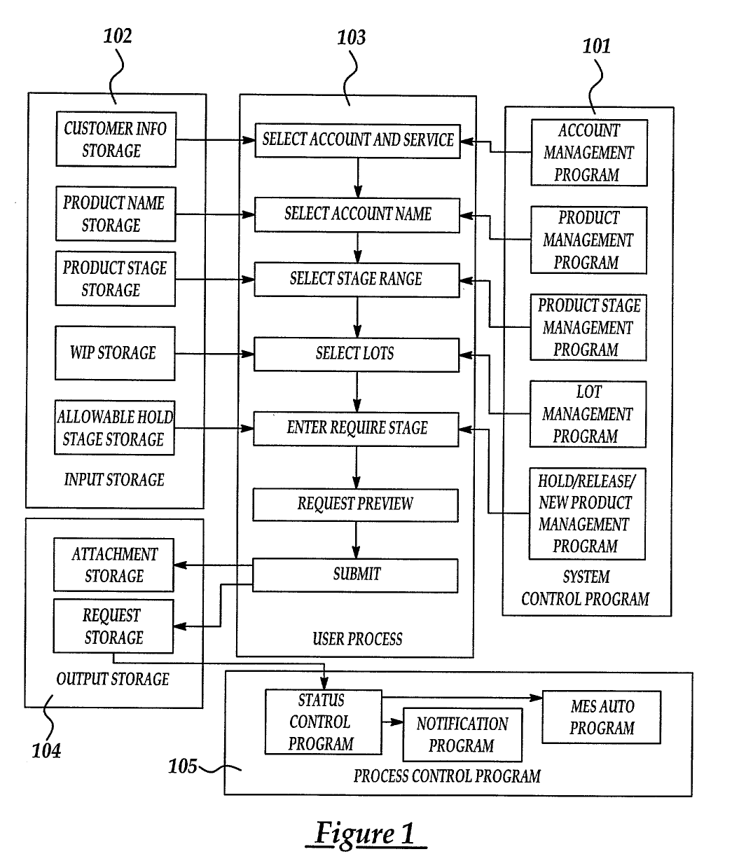

Referring now to FIG. 1, there is shown a schematic block diagram illustrating the interaction of various components which comprise at least in part a system in accord with the present invention.

As is understood by a person skilled in the art, a system in accord with the present invention will typically and preferably comprise a computer assisted system. The computer assisted system will typically and preferably employ a digital computer further comprising a digital processor and digital data storage components as are otherwise generally conventional in the art of microelectronic fabrication. Similarly, the computer assisted system in accord with the present invention will also include a customer accessible user interface which will typically and preferably include a graphical user interface and a keyboard. In particular with respect to customer access to the computer assisted system of the present invention, customer access is typically and preferably effected through customer access to a distributed communications network, and in particular an Internet distributed communications network. Within the present invention, a “customer” is intended as an end user entity having a work in process (WIP) workload lot fabricated within a fabrication facility having incorporated therein a system in accord with the present invention, wherein the end user entity would not conventionally have direct control over fabrication of the work in process (WIP) workload lot within the fabrication facility.

Referring again to FIG. 1, and in accord with the block which corresponds with reference numeral 101, there is provided within the system of the present invention various system control programs which assist in managing work in process (WIP) workload within a fabrication facility. In accord with the block which corresponds with reference numeral 101, the various system control programs include an account management program, a product management program, a product stage management program, a lot management program and a hold/release/new product management program. The functions of each of the foregoing system control programs may be effected and implemented while employing software as is otherwise generally conventional in the art of microelectronic fabrication facility management and control. Custom applications software may, however, also be employed with respect to the foregoing system control programs, but such is not required within the context of the present invention.

Referring again to FIG. 1, and in accord with the block which corresponds with reference numeral 102, there is shown a series of input storage components within the system of the present invention. The series of input storage components includes, but is not limited to customer information storage, product name storage, product stage storage, work in process (WIP) information storage and allowable hold stage information storage. The foregoing series of input storage components within the system of the present invention is intended to store correlating information for each work in process (WIP) workload lot within a microelectronic fabrication facility within which is employed the system whose schematic block diagram is illustrate in FIG. 1. As indicated above, the information may be stored within digital storage components as are otherwise conventional.

Referring again to FIG. 1, and in accord with the block which corresponds with reference numeral 103, there is shown a series of user process component steps in accord with operation of the system of the present invention. As is illustrated within the schematic block diagram of FIG. 1, the series of user process component steps draws from the correlating input storage components as illustrated in conjunction with reference numeral 102 and the correlating system control program components as illustrated in conjunction with reference numeral 101. As is further illustrated within the block which corresponds with reference numeral 103, and in sequence, a user of the system whose schematic block diagram is illustrated in FIG. 1: (1) first selects an account and a service; (2) then selects a product name; (3) then selects a range of fabrication stages; (4) then selects at least one lot from the range of fabrication stages; (5) then enters a required stage at which a hold or release may be effected for a particular product lot; (6) then previews the request; and finally (7) then submits the request.

Incident to submitting the request as a result of the series of user process component steps in accord with the block which corresponds with reference numeral 103, and in accord with the block which corresponds with reference numeral 104, an output storage component of the system whose schematic block diagram is illustrated in FIG. 1 stores the request, with an attachment, as appropriate.

Finally, and referring again to FIG. 1, there is shown in accord with the block which corresponds with reference numeral 105 a last component of the system of the present invention, and in particular a process control program component. As is illustrated within the block which corresponds with reference numeral 105 the stored request from the output storage component is employed to provide an update to a status control program, a notification program and a manufacturing execution system auto program, such as to effect the request submitted from the user process component in accord with the block which corresponds with reference numeral 103.

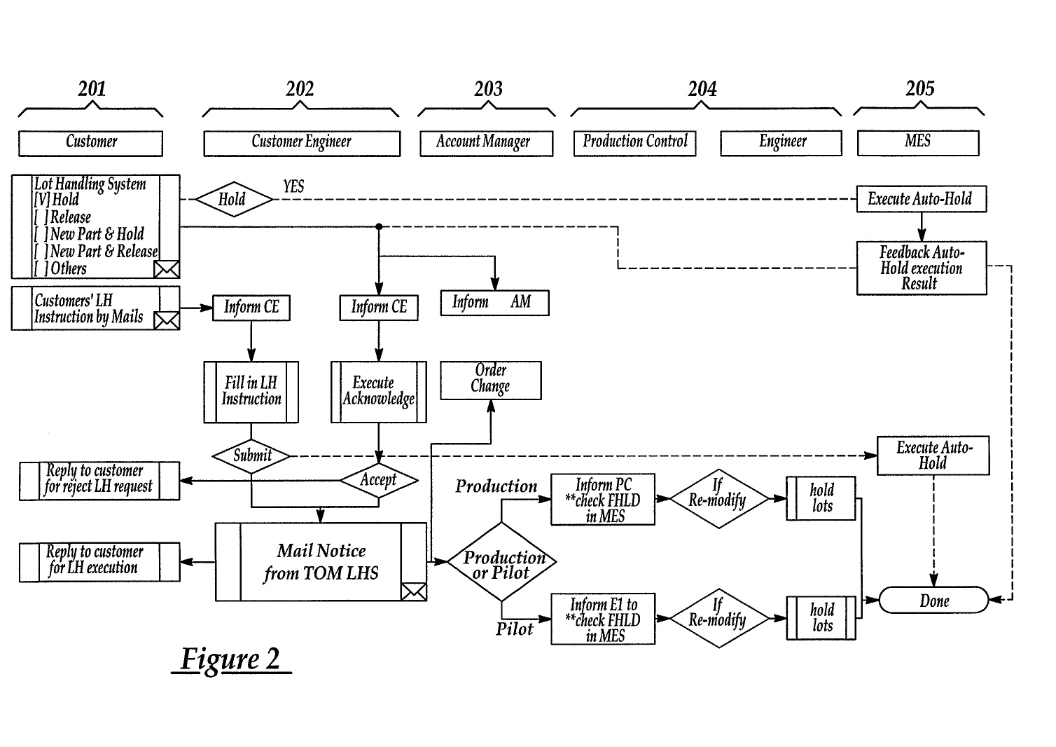

Referring now to FIG. 2, there is shown a schematic block diagram illustrating, in a more detailed fashion with respect to a series of individual production entities which may operate in accord with the system whose schematic block diagram is illustrated in FIG. 1, a method for use of the system in accord with the schematic block diagram of FIG. 1.

Referring to FIG. 2, and in accord with the block which corresponds with reference numeral 201, there is shown a series of process steps of the method of the present invention with respect to a customer having fabricated within a fabrication facility at least one work in process (WIP) workload lot. Progressing from the top to the bottom of the block which corresponds with reference numeral 201 (as will similarly also be done for subsequent blocks), a customer may in a first instance submit lot handling instructions directly to the manufacturing execution system (MES) instruction handling system of the present invention absent any direct intervening communication to a fabrication facility representative, such as a customer engineer. The process for such submission is outlined within the block which corresponds with reference numeral 103 within FIG. 1, where a “customer” is the “user.” In the alternative, the customer may independently submit lot handling instructions as written instructions through the mails. Independent of method of submission, the customer will receive in return a confirmation which indicates either acceptance or rejection of the lot handling request initiated by the customer. Such confirmation indicating acceptance or rejection is provided through a customer engineer.

Referring again to FIG. 2, and in accord with the block which corresponds with reference numeral 202, there is shown a series of process steps with respect to the customer engineer in accord with the method of the present invention. As is illustrated within the block which corresponds with reference numeral 202, the customer engineer provides an interface for either direct or indirect receipt of the lot handling request initiated by the customer. The customer engineer has a prime responsibility for assuring that a response to the lot handling request, whether acceptance or rejection, is timely provided to the customer.

Referring again to FIG. 2, and in accord with the block which corresponds with reference numeral 203, there is shown a series of process steps with respect to an account manager in accord with the method of the present invention. In accord with the block which corresponds with reference numeral 203, the account manager is informed of the lot handling request by the customer engineer. The account manager then appropriately revises the customer's order, while making a determination whether the lot handling request effects a change in the customer's order from a production order to a pilot order, or the reverse.

Referring again to FIG. 2, and in accord with the block which corresponds with reference numeral 204, there is shown a series of process steps with respect to production control and engineering in accord with the method of the present invention. As is shown within the block which corresponds with reference numeral 204, and upon input from the account manager, either production control or engineering may be independently directed to hold a work in process (WIP) workload lot, or a series of work in process (WIP) workload lots, as originally requested by the customer.

Finally, and referring again to FIG. 2, and in accord with the block which corresponds with reference numeral 205, there is shown with respect to a manufacturing execution system a series of activities in accord with the method of the present invention. As is illustrated in accord with reference numeral 205, the manufacturing execution system may receive a lot hold request directly from a customer absent an intervening customer engineer, and forward a reply back to the customer through the customer engineer. In addition, and as noted above, the manufacturing execution system may also receive a request from the customer engineer on behalf of the customer.

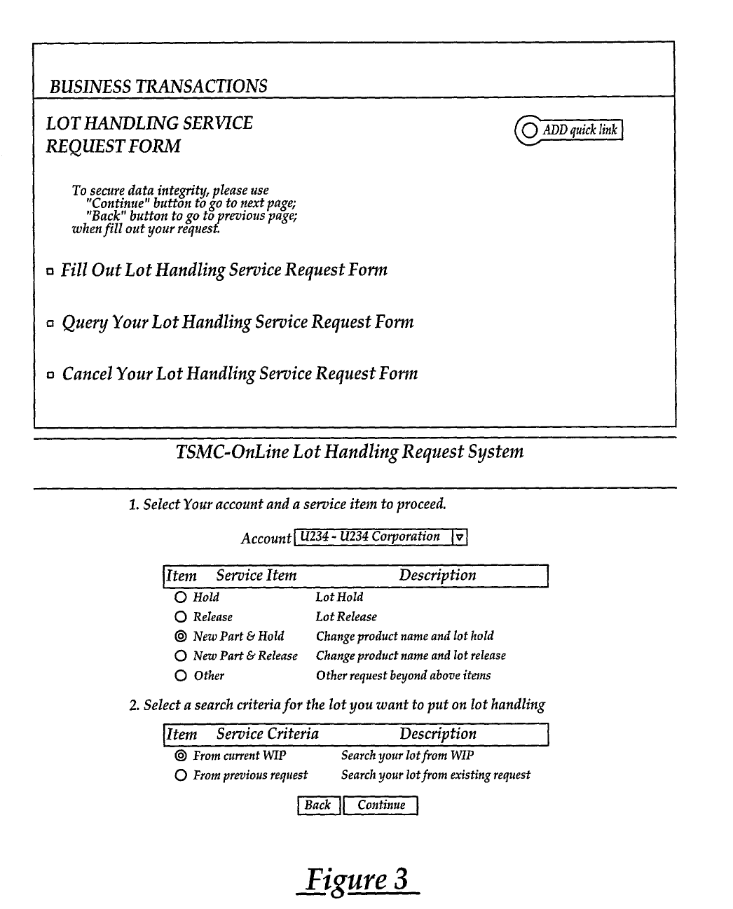

Referring now to FIG. 3 to FIG. 8, there is show a series of user interface screens which may be employed within the context of a distributed communications network, such as but not limited to an Internet distributed communications network, incident to implementation of the method of the present invention in accord with the schematic block diagram of FIG. 2 while employing the system of the present invention in accord with the schematic block diagram of FIG. 1.

Referring in particular to FIG. 3, there is shown an initial user interface screen of a Lot Handling Service Request Form in accord with the present invention. As is illustrated within FIG. 3, the Lot Handling Service Request Form provides an opportunity for input of an account number, a service item and a work in process (WIP) lot source.

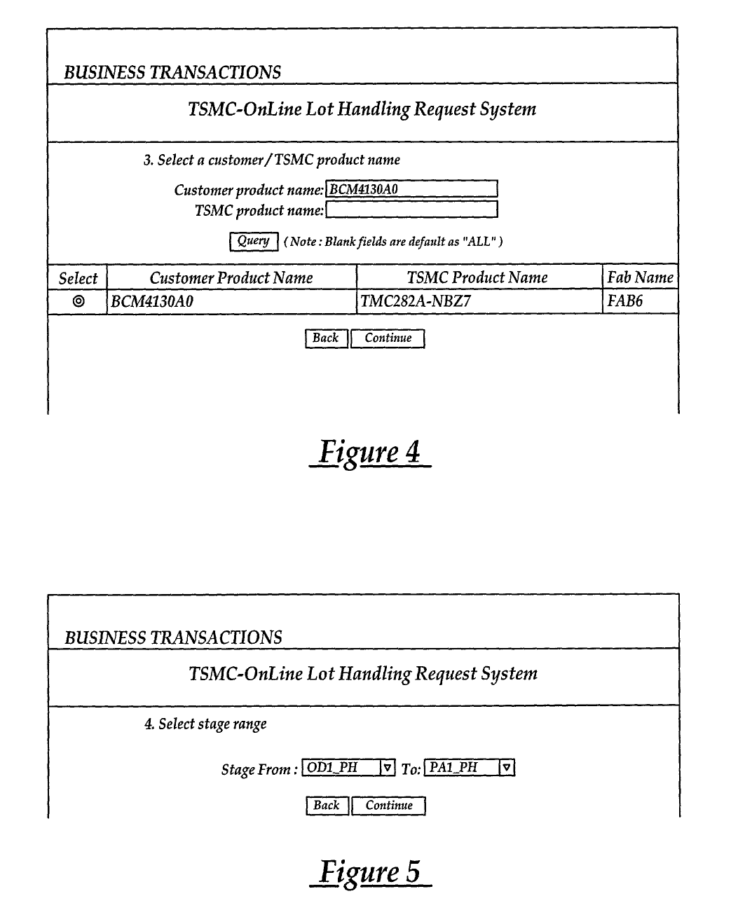

Referring now to FIG. 4, there is shown the next user interface screen in accord with the present invention.

Shown in FIG. 4 is a user interface screen which provides for selection of a customer product number and a vendor product number from a list inclusive of all customer product numbers and vendor product numbers.

Referring now to FIG. 5, there is shown the next user interface screen in accord with the preferred embodiment of the present invention.

As is shown within the user interface screen of FIG. 5, there is provided an opportunity to select a process stage corresponding with the work in process (WIP) lot which corresponds with customer number and vendor number as designated within the user interface screen of FIG. 4.

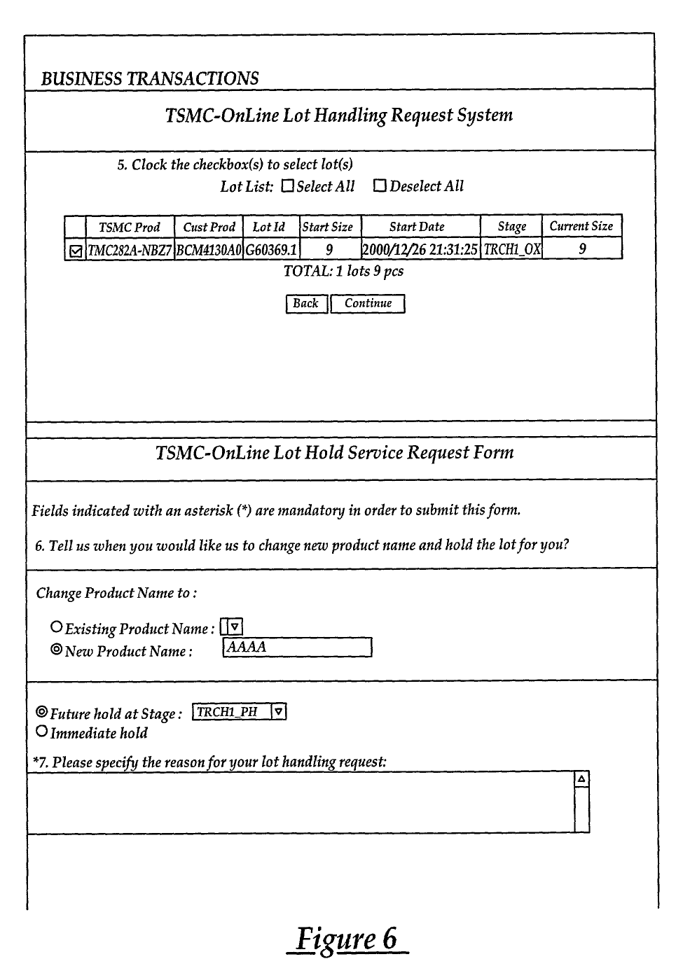

Referring now to FIG. 6, there is shown the next user interface screen in accord with the preferred embodiment of the present invention.

As is shown within the user interface screen of FIG. 6, there is provided an opportunity to select lots from a lot list, rename products and provide any additional comments.

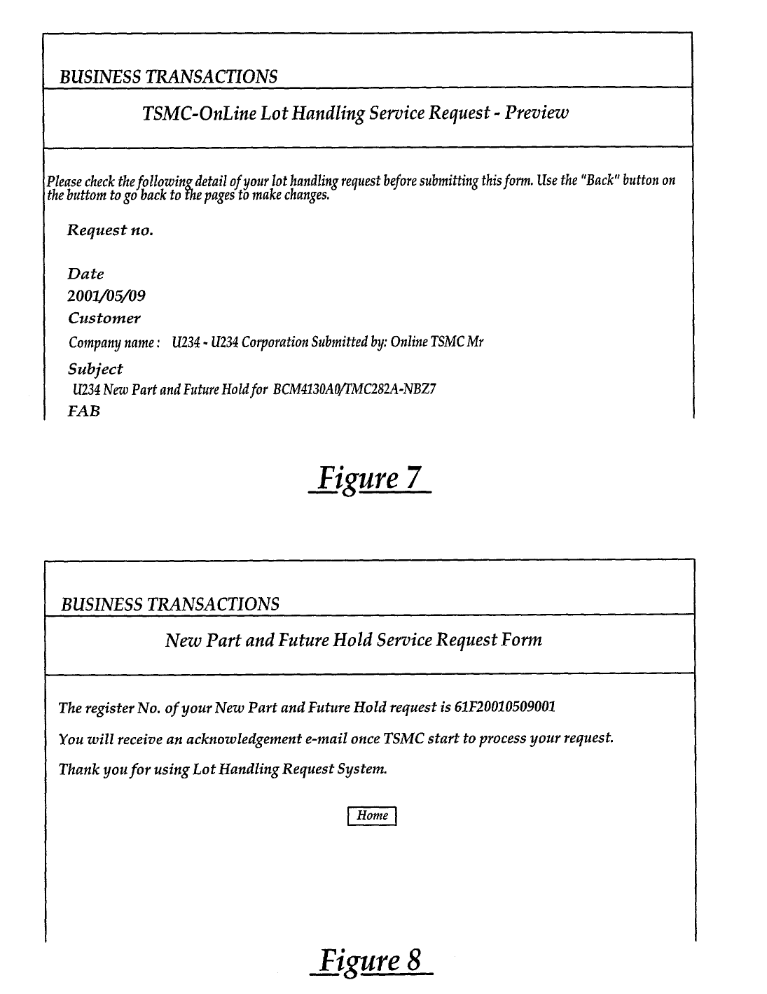

Referring now to FIG. 7, there is shown the next user interface screen in accord with the preferred embodiment of the present invention.

As is shown within the user interface screen of FIG. 7, there is provided a preview of the Lot Handling Service Request effected through entry of data within the user interface screens of FIG. 3 to FIG. 6.

Referring finally to FIG. 8, there is shown the last user interface screen in accord with the preferred embodiment of the present invention.

As is shown within the user interface screen of FIG. 8, there is a confirmed the Lot Handling Service Request as previewed within the user interface screen of FIG. 7, and assigned thereto a confirmation number.

Upon executing the method of the present invention in accord with the schematic block diagram of FIG. 2 while employing the system of the present invention whose schematic block diagram is illustrated in FIG. 1, further within the context of the series of user interface screens of FIG. 3 to FIG. 8, there is provided in accord with the present invention both a system for more flexibly managing a work in process (WIP) workload within a fabrication facility and a method for more efficiently managing the work in process (WIP) workload within a fabrication facility. The system of the present invention and the method of the present invention realize the foregoing object by providing within the system of the present invention and the method of the present invention that a customer may directly access and modify handling instructions for a work in process (WIP) workload lot within the fabrication facility.

As is understood by a person skilled in the art, the preferred embodiment of the present invention is illustrative of the present invention rather than limiting of the present invention. Revisions and modifications may be made to systems and methods in accord with the preferred embodiment of the present invention while still providing a system in accord with the present invention and a method in accord with the present invention, further in accord with the accompanying claims.

What is claimed is:

1. A computer assisted system for managing a work in process workload comprising:
means for storing identifying information for a work in process workload lot;
means for accessing the identifying information for the work in process workload lot;
means for requesting and effecting a change in production of the work in process workload lot after accessing the identifying information for the work in process workload lot, wherein the means for requesting the change in production of the work in process workload lot provides for direct access by a customer.

2. The system of claim 1 wherein the system is employed within a fabrication facility selected from the group consisting of electrical fabrication facilities, chemical fabrication facilities and mechanical fabrication facilities.

3. The system of claim 1 wherein the system is employed within a microelectronic fabrication facility selected from the group consisting of integrated circuit microelectronic fabrication facilities, ceramic substrate microelectronic fabrication facilities, solar cell optoelectronic microelectronic fabrication facilities, sensor image array optoelectronic microelectronic fabrication facilities and display image array optoelectronic microelectronic fabrication facilities.

4. The system of claim 1 wherein the change in production of the work in process workload lot is requested directly by the customer without an intervening approval by a customer engineer.

5. The system of claim 1 wherein the computer assisted system is accessible by the customer through a distributed communications network.

6. The system of claim 1 wherein the computer assisted system is accessible by the customer through an Internet distributed communications network.

7. A method for managing a work in process workload comprising:
providing a computer assisted system for managing a work in process workload lot, the computer assisted system comprising:
means for storing identifying information for the work in process workload lot;
means for accessing the identifying information for the work in process workload lot; and
means for requesting and effecting a change in production of the work in process workload lot after accessing the identifying information for the work in process workload lot, wherein the means for requesting the change in production of the work in process workload lot provides for direct access by a customer; and
requesting the change in production of the work in process workload lot directly by the customer.

8. The method of claim 7 wherein the system is employed within a fabrication facility selected from the group consisting of electrical fabrication facilities, chemical fabrication facilities and mechanical fabrication facilities.

9. The method of claim 7 wherein the system is employed within a microelectronic fabrication facility selected from the group consisting of integrated circuit microelectronic fabrication facilities, ceramic substrate microelectronic fabrication facilities, solar cell optoelectronic microelectronic fabrication facilities, sensor image array optoelectronic microelectronic fabrication facilities and display image array optoelectronic microelectronic fabrication facilities.

10. The method of claim 7 wherein the change in production of the work in process workload lot is requested directly by the customer without an intervening approval by a customer engineer.

11. The method of claim 7 wherein the computer assisted system is accessible by the customer through a distributed communications network.

12. The method of claim 7 wherein the computer assisted system is accessible by the customer through an Internet distributed communications network.
